(19) United States
(12) Patent Application Publication
(10) Pub. No.: US 2026/0024966 A1
(43) Pub. Date: Jan. 22, 2026

(54) CONDUCTOR TERMINATIONS

(71) Applicant: AFL Telecommunications LLC, Duncan, SC (US)

(72) Inventor: Matthew G. Welborn, Greenville, SC (US)

(21) Appl. No.: 18/869,599

(22) PCT Filed: May 19, 2023
(86) PCT No.: PCT/US2023/022862

§ 371 Date: Nov. 26, 2024

Related U.S. Application Data
(60) Provisional application No. 63/346,751, filed on May 27, 2022.

(51) Int. Cl. H02G 1/04; H01R 4/50; H01R 11/14

(52) U.S. Cl. CPC H02G 1/04; H01R 4/5041; H01R 4/5083; H01R 11/14

(57) ABSTRACT

Conductor terminations are provided. A conductor termination defines a longitudinal axis, a lateral axis, and a transverse axis. The conductor termination includes a body extending along the longitudinal axis, the body including a head and a tail, the head defining a channel and a slot, the channel and slot each extending along the longitudinal axis through a length of the head. The conductor termination further includes a keeper, the keeper defining a channel which extends along the longitudinal axis and including a wing protruding along the lateral axis. The keeper is insertable into the body in a direction along the longitudinal axis away from the tail.

### FIELD

The present disclosure relates generally to improved conductor attachment accessories for aerial conductors.

### BACKGROUND

Conductors are utilized in a variety of environments for carrying electrical current and generally facilitating the transmission of electricity. Conductor attachment accessories are utilized to connect the conductors to other conductors or to other components of the energy transmission assembly such as other conductor connector accessories or the tower. Examples of conductor attachment accessories include terminations (such as dead ends), splices, terminals, repair sleeves, t-taps, t-connectors, jumper connectors, etc.

In many cases, the conductors are installed in relatively high tension. Due to the relatively high tension environments, it is desirable for the connection between a conductor attachment accessory and conductor to be robust, thereby preventing relative movement between the conductor and attachment accessory and/or disconnection of the conductor from the attachment accessory.

Existing conductor attachment accessories, and particularly terminations, require the use of multiple different parts which must be assembled together in order to grip the conductor. Some such existing accessories require tightening of bolts to secure various other components together. Such installations are time-consuming and difficult. Further, in some cases, such installations can be risk-prone if, for example, the bolts are not adequately tightened.

Additionally, some such existing accessories pierce the outer jacket of the conductor being secured, which damages and reduces the usable life of the conductor. Additionally, such damage can potentially lead to environmental impacts such as forest fires.

Accordingly, improved conductor attachment accessories are desired in the art. In particular, improved terminations which reduce the time, complexity, and risk of installation and/or which reduce or eliminate damage to the associated conductor would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a conductor termination defines a longitudinal axis, a lateral axis, and a transverse axis. The conductor termination includes a body extending along the longitudinal axis, the body including a head and a tail, the head defining a channel and a slot, the channel and slot each extending along the longitudinal axis through a length of the head. The conductor termination further includes a keeper, the keeper defining a channel which extends along the longitudinal axis and including a wing protruding along the lateral axis. The keeper is insertable into the body in a direction along the longitudinal axis away from the tail.

In accordance with another embodiment, a conductor termination defines a longitudinal axis, a lateral axis, and a transverse axis. The conductor termination includes a body extending along the longitudinal axis, the body including a head and a tail, the head defining a channel and a slot, the channel and slot each extending along the longitudinal axis through a length of the head. The slot extends along the longitudinal axis at an angle to the longitudinal axis. A surface of the body defining the channel includes a waveform cross-sectional profile along the longitudinal axis. The conductor termination further includes a keeper, the keeper defining a channel which extends along the longitudinal axis and includes a wing protruding along the lateral axis. The wing is insertable into the slot.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is perspective view of a conductor termination terminating a conductor in accordance with embodiments of the present disclosure:

FIG. 2 is a perspective exploded view of a conductor termination in accordance with embodiments of the present disclosure:

FIG. 3 is a top view of a conductor termination in accordance with embodiments of the present disclosure:

FIG. 4 is a side cross-sectional view, along the line A-A, of FIG. 3;

FIG. 5 is a side exploded cross-sectional view of a conductor termination in accordance with embodiments of the present disclosure;

FIG. 6 is a front exploded view of a conductor termination in accordance with embodiments of the present disclosure:

FIG. 7 is a front assembled view of a conductor termination in accordance with embodiments of the present disclosure; and

FIG. 8 is a perspective view of a conductor utilized with a conductor termination in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present disclosure is directed to improved conductor terminations. Such terminations can be quickly and efficiently installed, and the risks associated with such installations are significantly reduced. Further, the use of such terminations does not require that the outer jacket of the associated conductor be pierced, thus extending the life of the associated conductor. Such advantages are achieved by, for example, the structure and components of the termination, which requires a body and a keeper that is removable connectable to the body. During installation, the keeper is installed in a direction generally towards the conductor and away from the connection of the termination to, for example, a pole, structure, or other suitable connection point. A wedge-or chock-like interaction between the keeper and body causes the grip of the keeper and body to tighten on the conductor as the conductor pulls away from the termination, thus advantageously securing the connection of the termination to the conductor.

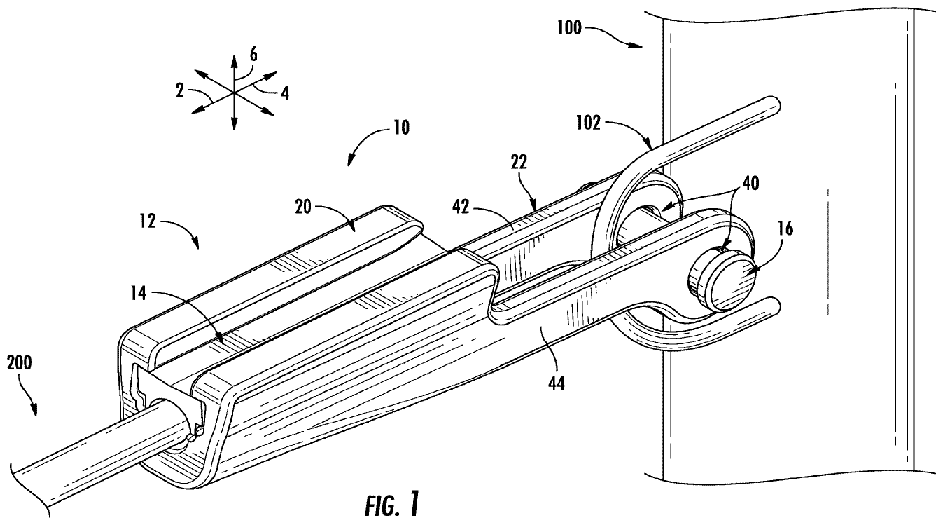

Referring now to the drawings, FIG. 1 illustrates a conductor termination 10 connected between a connection structure 100 and a conductor 200. The connection structure 100 may, for example, be a pole (such as a telephone or electrical pole), structural wall or tower, or other suitable structure.

Referring briefly to FIG. 8, one embodiment of a conductor 200 with which a conductor termination 10 may be utilized is provided. In exemplary embodiments, conductors 200 with which conductor terminations 10 are utilized may be “jacketed” (or “covered”) conductors. In exemplary embodiments, conductors terminations 10 in accordance with the present disclosure may be utilized with aluminum conductor composite reinforced (“ACCR”) conductors, aluminum conductor composite core (“ACCC”), aluminum conductor steel supported (“ACSS”) conductors. aluminum conductor composite supported (“ACCS”) conductors, aluminum conductor steel reinforced (“ACSR”) conductors, alumoweld (“AW”) conductors, all aluminum conductors (“AAC”), steel ground wire, or other suitable conductors. Conductors having single member cores, or multiple member cores (such as stranded cores) may be utilized. The core materials and outer layer materials may be the same or may be different.

As shown, in some embodiments, conductor 200 may include a plurality of conductor strands 202 which may be arranged as a central core 204 (which may include one, as shown, or more conductor strands 202) surrounded by one or more generally concentric layers of conductor strands, such as a first layer 206 and a second layer 208. each of which may include a plurality of conductor strands 202. The one or more layers 206, 208, may in some embodiments have a helical arrangement, with each strand 202 extending helically about a longitudinal axis of the conductor 200.

In exemplary embodiments, the conductor strands 202 of conductor 200 are formed from one or more metals. For example, in some embodiments, each conductor strand 202 is formed from a steel and/or an aluminum. The conductor strand(s) 202 of the core 204 may be formed from the same material as the strand(s) 206, 208 of the outer layer(s), or may be formed from a different material from the strand(s) 206, 208 of the outer layer(s). For example, the strand(s) 202 of the core 204 and/or the strand(s) of the outer layer(s) 206, 208 may be formed from steel, aluminum, aluminum fiber, aluminum reinforced with alumina fibers, carbon or glass fibers in a polymer matrix (such as an epoxy or a thermoplastic), or other suitable material(s).

In some embodiments, conductor 200 may further include one or more layers surrounding the conductor layers 206, 208. Such layers may, for example, be formed of non-conductive materials such as polymers. For example, in some embodiments, a polymer shield layer 210 may be provided on the outermost layer 208 of the conductor layers. Further, one or more jackets (such as two, three, four, or more jackets), such as an inner jacket 212 and an outer jacket 214, may be provided. Jackets 212, 214 may be formed from or include suitable polymers. For example, jackets 212, 214 may be formed from or include polyethylene, such as high density and/or crosslinked polyethylene, or another suitable thermoplastic.

Referring again to FIG. 1, conductor termination 10 may connect a conductor 200 and connection structure 100. The conductor termination 10 may include a body 12 and a keeper 14, and may further include a mechanical fastener 16, such as a bolt, screw, etc. The mechanical fastener 16 may extend through a tail of the body 12 and through a connection point 102 of the connection structure 100 to connect the conductor termination 10 to the connection structure 100.

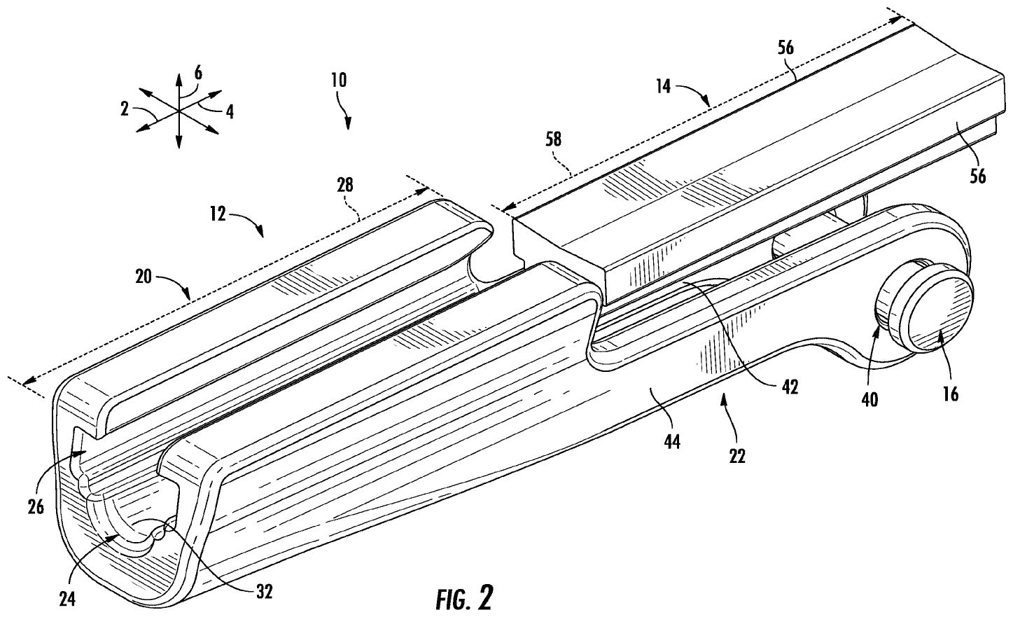

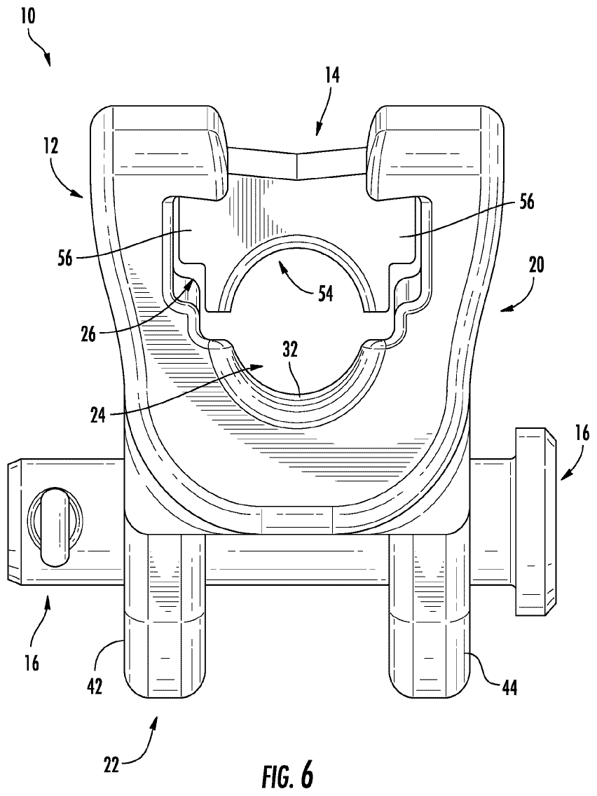

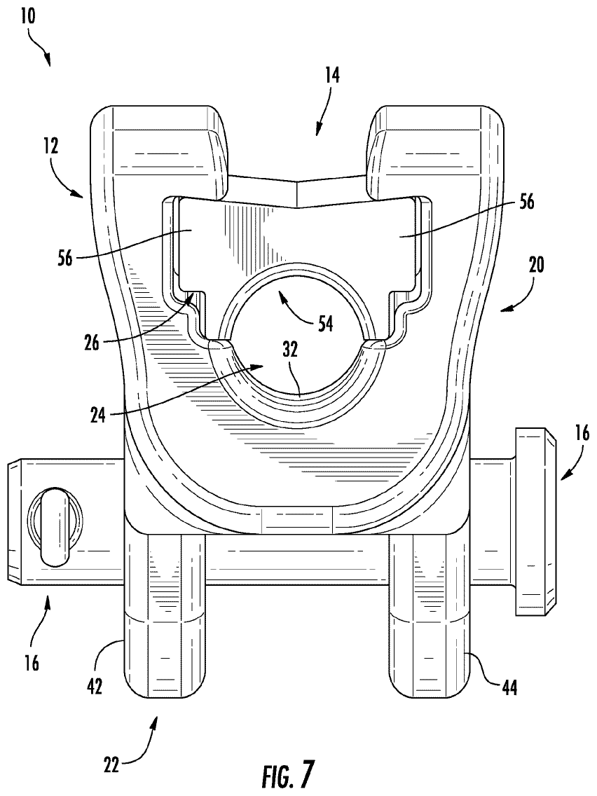

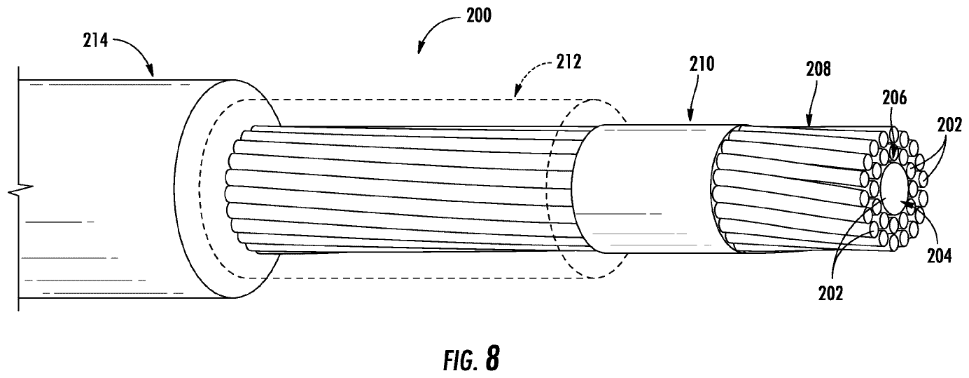

Referring now to FIGS. 1 through 7, details of conductor terminations 10 in accordance with embodiments of the present disclosure are provided. Such details may be discussed with reference to an orthogonal coordinate system in which the termination 10 defines a longitudinal axis 2, a lateral axis 4, and a transverse axis 6, each of which is orthogonal to the others of such axes.

As discussed, a conductor termination 10 may include a body 12. Body 12 may extend along the longitudinal axis 2, and may include a head 20 and a tail 22. The head 20 may connect to a conductor 200, while the tail 22 may connect to a connection structure 100.

Head 20 may, as discussed, extend along the longitudinal axis 2. Head 20 may further have a generally U-shaped cross-sectional profile which is shaped to accommodate a conductor 200 and the keeper 14. For example, head 20 may define a channel 24 and a slot 26, each of which extends along the longitudinal axis 2 through a length 28 of the head 20. Channel 24 may have a generally arc-shaped cross-sectional profile. Slot 26 may be spaced from the channel 24 along the transverse axis 6, and may protrude along the lateral axis 4 relative to the channel 24, such as in one or both directions along the lateral axis 4.

In some exemplary embodiments, slot 26 may extend along the longitudinal axis 2 at an angle 30 to the longitudinal axis 2, such as in an insertion direction of the keeper 14 towards the channel 24 in a direction along the longitudinal axis 2 away from the tail 22. Such angle 30 may advantageously facilitate the wedge- or chock-like interaction of the keeper 14 with the body 12 to secure a conductor 200. Such angle 30 may in some embodiments be between 1 degree and 20 degrees, such as between 2 degrees and 15 degrees, such as between 5 degrees and 10 degrees. In alternative embodiments. however, slot 26 may extend coaxially with longitudinal axis 2 such that angle 30 is zero.

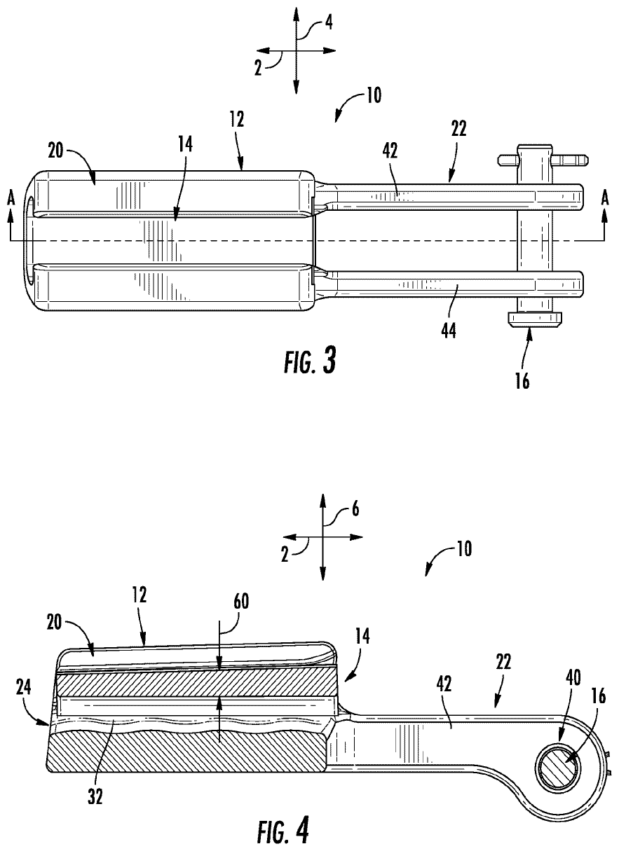

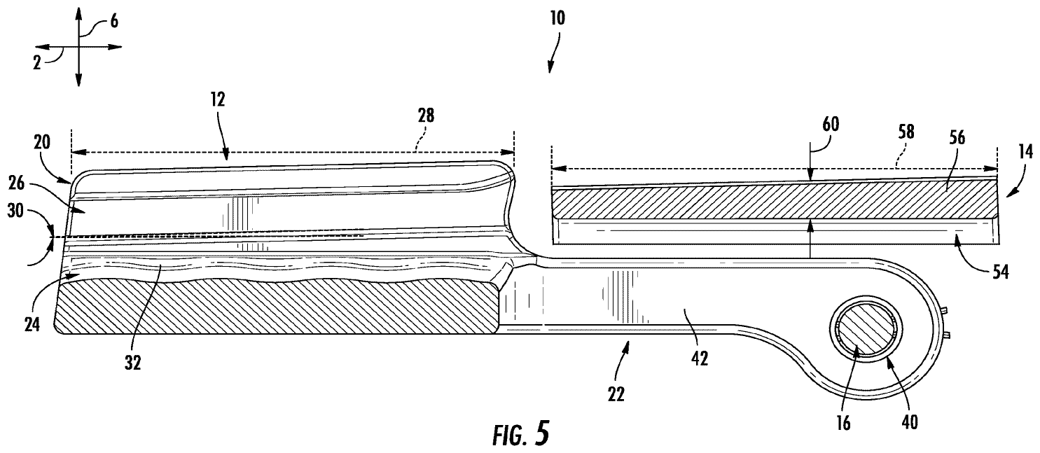

When assembled and installed, a conductor 200 may be disposed in the channel 24, and may thus contact a surface 32 of the body 12 which defines the channel 24. In some embodiments, such surface 32 includes a waveform cross-sectional profile along the longitudinal axis 2, as illustrated in FIG. 4. Such profile and resulting contact may secure the conductor 200 in the channel 24 while advantageously not requiring that the conductor 200 is pierced.

As discussed, body 12 may include a tail 22 which extends from the head 20, such as along the longitudinal axis 2. Tail 22 in exemplary embodiments is a clevis, as shown. Tail 22 may further define a connection aperture 40 through which mechanical fastener 16 may be inserted to connect the termination 10 to a connection structure 100. Further, in some embodiments, tail 22 may include a first tail section 42 and a second tail section 44, each of which defines an aperture 40 through which the mechanical fastener 16 is inserted. The first and second tails 42, 44 may each extend from the head 20, and may be spaced apart from each other along the lateral axis 4. In some embodiments, connector point 102 may be inserted between the first and second tails 42, 44 (along the lateral axis 4) to connect the termination to the connection structure 100.

As discussed, keeper 14 may be inserted into body 12, such as the head 20 thereof, to assembly the termination 10 and connect the termination 10 to a conductor 200. The keeper 14 may, when assembled, extend along the longitudinal axis 2. Keeper 14 may further have a generally U-shaped cross-sectional profile which is shaped to accommodate a conductor 200 and fit within the body 12. For example, keeper 14 may define a channel 54 and include one or more wings 56, each of which extends along the longitudinal axis 2 through a length 58 of the keeper 14. Channel 54 may have a generally arc-shaped cross-sectional profile. Wings 56 may be spaced from the channel 54 along the transverse axis 6, and may protrude along the lateral axis 4 relative to the channel 54, such as in one or both directions along the lateral axis 4.

In some exemplary embodiments, a thickness 60 of the wings 56 (along the transverse axis 6) may taper along the longitudinal axis 2, such as in an insertion direction of the keeper 14 away from the tail 22. Such taper may advantageously facilitate the wedge-or chock-like interaction of the keeper 14 with the body 12 to secure a conductor 200.

Keeper 14 may be insertable into the body 12, such as into the head 20 thereof, in a direction along the longitudinal axis 2 away from the tail 22. In some exemplary embodiments. the keeper 14 may be insertable into the body 12 in only a single direction, which is the direction along the longitudinal axis 2 away from the tail 22. When being assembled, the wing(s) 56 are insertable into the slot 26, such that the wings(s) 56 are disposed in the slot 26 when the termination 10 is assembled. When assembled and connected to a conductor 200, the conductor 200 is disposed in the channel 54 as well as the channel 24, which together may define a passage through which the conductor 200 extends. The various angles, tapers, and/or cross-sectional profiles as discussed herein may advantageously efficiently, easily, and in a risk-free, reduced damage manner secure the conductor 200 to the termination 10.

In exemplary embodiments, the body 12 and keeper 14 are formed from suitable metals, such as aluminum. For example, the body 12 may be an aluminum (or other suitable metal) casting, and the keeper 14 may be an aluminum (or other suitable metal) extrusion. Mechanical fastener 16 may also be formed from a suitable metal, such as steel.

Further aspects of the invention are provided by one or more of the following embodiments:

A conductor termination defining a longitudinal axis, a lateral axis, and a transverse axis, the conductor termination including a body extending along the longitudinal axis, the body including a head and a tail, the head defining a channel and a slot, the channel and slot each extending along the longitudinal axis through a length of the head; and a keeper, the keeper defining a channel which extends along the longitudinal axis and including a wing protruding along the lateral axis, wherein the keeper is insertable into the body in a direction along the longitudinal axis away from the tail.

A conductor termination defining a longitudinal axis, a lateral axis, and a transverse axis, the conductor termination including a body extending along the longitudinal axis, the body including a head and a tail, the head defining a channel and a slot, the channel and slot each extending along the longitudinal axis through a length of the head, wherein the slot extends along the longitudinal axis at an angle to the longitudinal axis, and wherein a surface of the body defining the channel including a waveform cross-sectional profile along the longitudinal axis: and a keeper, the keeper defining a channel which extends along the longitudinal axis and including a wing protruding along the lateral axis, wherein the wing is insertable into the slot.

The conductor termination of any one or more embodiments herein, wherein the keeper is insertable into the body in a direction along the longitudinal axis away from the tail.

The conductor termination of any one or more embodiments herein, wherein the wing is insertable into the slot.

The conductor termination of any one or more embodiments herein. wherein the wing is a plurality of wings, each of the plurality of wings protruding along the lateral axis.

The conductor termination of any one or more embodiments herein, wherein a thickness of the wing along the transverse axis tapers along the longitudinal axis.

The conductor termination of any one or more embodiments herein, wherein the taper is in the insertion direction.

The conductor termination of any one or more embodiments herein, wherein the slot extends along the longitudinal axis at an angle to the longitudinal axis.

The conductor termination of any one or more embodiments herein, wherein the slot extends towards the channel in the insertion direction.

The conductor termination of any one or more embodiments herein, wherein a surface of the body defining the channel comprises a waveform cross-sectional profile along the longitudinal axis.

The conductor termination of any one or more embodiments herein, wherein the tail defines a connection aperture.

The conductor termination of any one or more embodiments herein, wherein the tail comprises a first tail section and a second tail section spaced apart from each other along the lateral axis.

The conductor termination of any one or more embodiments herein, wherein the body and the keeper are formed from aluminum.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A conductor termination, the conductor termination defining a longitudinal axis, a lateral axis, and a transverse axis, the conductor termination comprising:
a body extending along the longitudinal axis, the body comprising a head and a tail, the head defining a channel and a slot, the channel and slot each extending along the longitudinal axis through a length of the head; and
a keeper, the keeper defining a channel which extends along the longitudinal axis and comprising a wing protruding along the lateral axis,
wherein the keeper is insertable into the body in a direction along the longitudinal axis away from the tail.

2. The conductor termination of claim 1, wherein the wing is insertable into the slot.

3. The conductor termination of claim 1, wherein the wing is a plurality of wings, each of the plurality of wings protruding along the lateral axis.

4. The conductor termination of claim 1, wherein a thickness of the wing along the transverse axis tapers along the longitudinal axis.

5. The conductor termination of claim 4, wherein the taper is in the insertion direction.

6. The conductor termination of claim 1, wherein the slot extends along the longitudinal axis at an angle to the longitudinal axis.

7. The conductor termination of claim 6, wherein the slot extends towards the channel in the insertion direction.

8. The conductor termination of claim 1, wherein a surface of the body defining the channel comprises a waveform cross-sectional profile along the longitudinal axis.

9. The conductor termination of claim 1. wherein the tail defines a connection aperture.

10. The conductor termination of claim 1, wherein the tail comprises a first tail section and a second tail section spaced apart from each other along the lateral axis.

11. The conductor termination of claim 1, wherein the body and the keeper are formed from aluminum.

12. A conductor termination, the conductor termination defining a longitudinal axis, a lateral axis, and a transverse axis, the conductor termination comprising:
a body extending along the longitudinal axis, the body comprising a head and a tail, the head defining a channel and a slot, the channel and slot each extending along the longitudinal axis through a length of the head, wherein the slot extends along the longitudinal axis at an angle to the longitudinal axis, and wherein a surface of the body defining the channel comprises a waveform cross-sectional profile along the longitudinal axis; and
a keeper, the keeper defining a channel which extends along the longitudinal axis and comprising a wing protruding along the lateral axis, wherein the wing is insertable into the slot.

13. The conductor termination of claim 12, wherein the keeper is insertable into the body in a direction along the longitudinal axis away from the tail.

14. The conductor termination of claim 12, wherein the wing is a plurality of wings, each of the plurality of wings protruding along the lateral axis.

15. The conductor termination of claim 12, wherein a thickness of the wing along the transverse axis tapers along the longitudinal axis.

16. The conductor termination of claim 15, wherein the taper is in the insertion direction.

17. The conductor termination of claim 12, wherein the slot extends towards the channel in the insertion direction.

18. The conductor termination of claim 12, wherein the tail defines a connection aperture.

19. The conductor termination of claim 12, wherein the tail comprises a first tail section and a second tail section spaced apart from each other along the lateral axis.

20. The conductor termination of claim 12, wherein the body and the keeper are formed from aluminum.
